(19) United States
(12) Patent Application Publication
(10) Pub. No.: US 2026/0261062 A1
(43) Pub. Date: Sep. 3, 2026

(54) INTERFACE CONNECTION STRUCTURE

(71) Applicant: ASUSTeK COMPUTER INC., Taipei City (TW)

(72) Inventors: Kuan-Chuan Wang, Taipei City (TW); Yi-Hong Lin, Taipei City (TW); Chin-Chuan Wu, Taipei City (TW); Wei-Chia Liao, Taipei City (TW)

(73) Assignee: ASUSTeK COMPUTER INC., Taipei City (TW)

(21) Appl. No.: 19/087,565

(22) Filed: Mar. 23, 2025

(30) Foreign Application Priority Data
Mar. 3, 2025 (TW) 114202089

(51) Int. Cl. H01R 12/71; H01R 13/533

(52) U.S. Cl. CPC H01R 12/716; H01R 13/533

(57) ABSTRACT

An interface connection structure adapted to a circuit board is provided. The circuit board has a connector with a slot extending along a plugging direction. The interface connection structure includes a base and a heat dissipation connection structure. The base is disposed on the circuit board and includes a connector opening. The connector is located in the connector opening. A second casing of the heat dissipation connection structure is movably connected to a first casing of the heat dissipation connection structure and encloses an accommodation space. The first casing includes a connection opening, and the accommodation space is adapted to dispose at least one interface device with a connection portion. When the interface device is disposed in the accommodation space, the connection portion of the interface device is exposed from the connection opening and the heat dissipation connection structure is adapted to connect to the base.

### CROSS-REFERENCE TO RELATED APPLICATION

The disclosure claims the priority benefit of Taiwan application serial no. 114202089, filed on Mar. 3, 2025. The entirety of the above-mentioned patent application is hereby incorporated by reference herein and made a part of this specification.

### BACKGROUND

### Technical Field

The disclosure relates to a connection structure, and particularly relates to an interface connection structure.

### Description of Related Art

Nowadays, when an interface device (such as an M.2 interface card) is electrically connected to a circuit board, it needs to be connected to a corresponding connector on the circuit board through an adaption board. The interface device is screwed to the adaption board, and the adaption board is screwed to the circuit board, which is unfavorable for the assembly and disassembly of the interface device and the adaption board. The screws require specific tools for disassembly and assembly, which is inconvenient to use. During the fastening process, problems such as screw dropping, improper fastening, and damage to the circuit board due to careless use of tools may easily occur.

### SUMMARY

The disclosure provide an interface connection structure that facilitates the connection of an interface device to a circuit board.

The interface connection structure of the disclosure is adapted to a circuit board. The circuit board has at least one connector, each of the at least one connector having a slot. The slot extends along a plugging direction, and the plugging direction is perpendicular to the circuit board. The interface connection structure includes a base and a heat dissipation connection structure. The base is disposed on the circuit board, and the base includes at least one connector opening. The at least one connector is located within the at least one connector opening. The heat dissipation connection structure may be detachably connected to the base along the plugging direction. The heat dissipation connection structure includes a first casing and a second casing, the second casing is movably connected to the first casing and encloses an accommodation space with the first casing. The first casing includes at least one connection opening, the accommodation space is adapted to be disposed with at least one interface device, and each of the at least one interface device has a connecting portion. When the interface device is disposed in the accommodation space, the connecting portion is exposed from the connection opening, the heat dissipation connection structure may be connected to the base along the plugging direction, thereby inserting the connecting portion into the slot.

Based on the above, the heat dissipation connection structure of the interface connection structure of the disclosure is used to hold the interface device, with the connecting portion of the interface device exposed from the heat dissipation connection structure. The base of the interface connection structure is set on the circuit board, and the heat dissipation connection structure may be inserted into the base, thereby allowing the connecting portion of the interface device to directly and stably connect with the connector of the circuit board.

### BRIEF DESCRIPTION OF THE DRAWINGS

FIG. 1 is a schematic diagram of an interface connection structure according to an embodiment of the disclosure.

FIG. 2 is a cross-sectional view of the interface connection structure of FIG. 1.

FIG. 3 is an exploded view of the interface connection structure of FIG. 1.

FIG. 4 is a schematic diagram of the base of FIG. 3.

FIG. 5 is a schematic diagram of the heat dissipation connection structure of FIG. 3 after being opened.

FIG. 6 is an exploded view of the heat dissipation connection structure of FIG. 3.

FIG. 7 is a schematic diagram of the fourth component of FIG. 6 in the first position.

FIG. 8 is a partially enlarged view of the fourth component of FIG. 7.

FIG. 9 is a schematic diagram of the fourth component of FIG. 7 in the second position.

FIG. 10 is a partially enlarged view of the fourth component of FIG. 9.

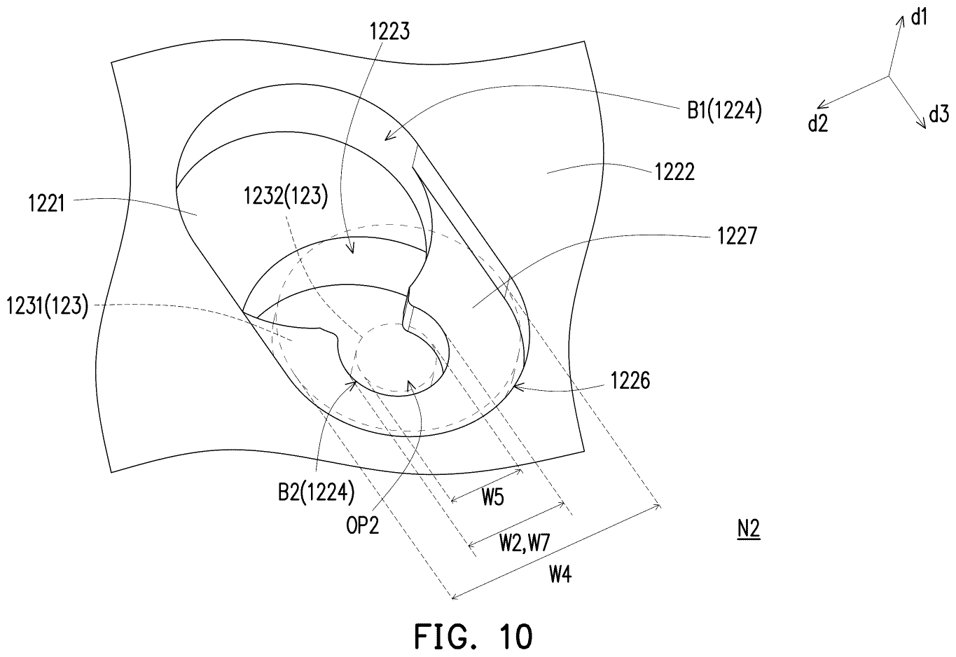

### DESCRIPTION OF THE EMBODIMENTS

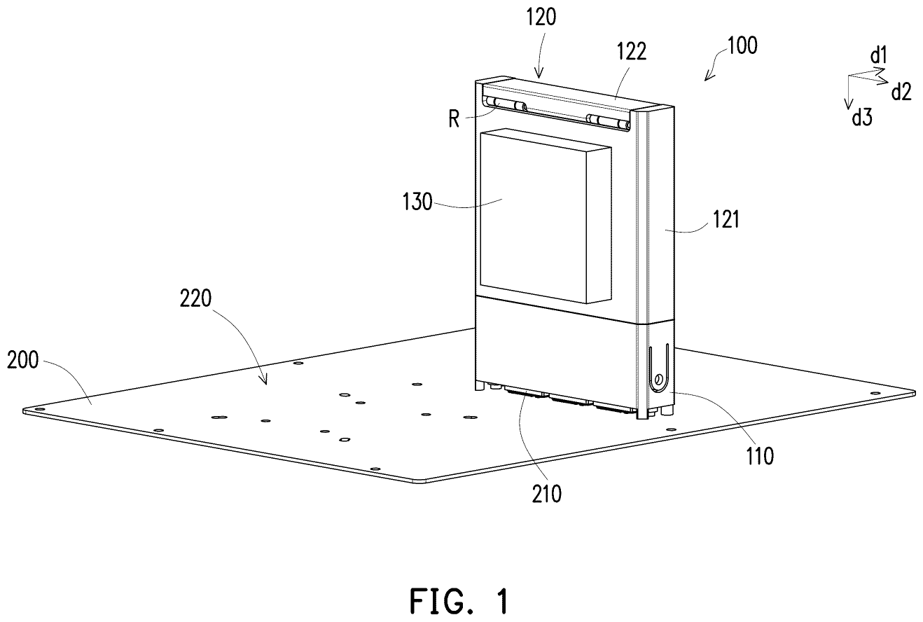

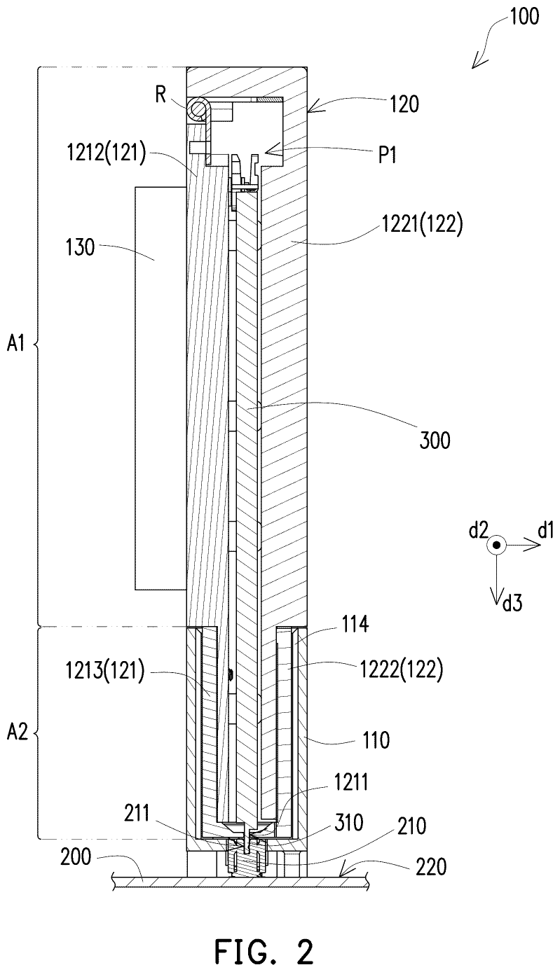

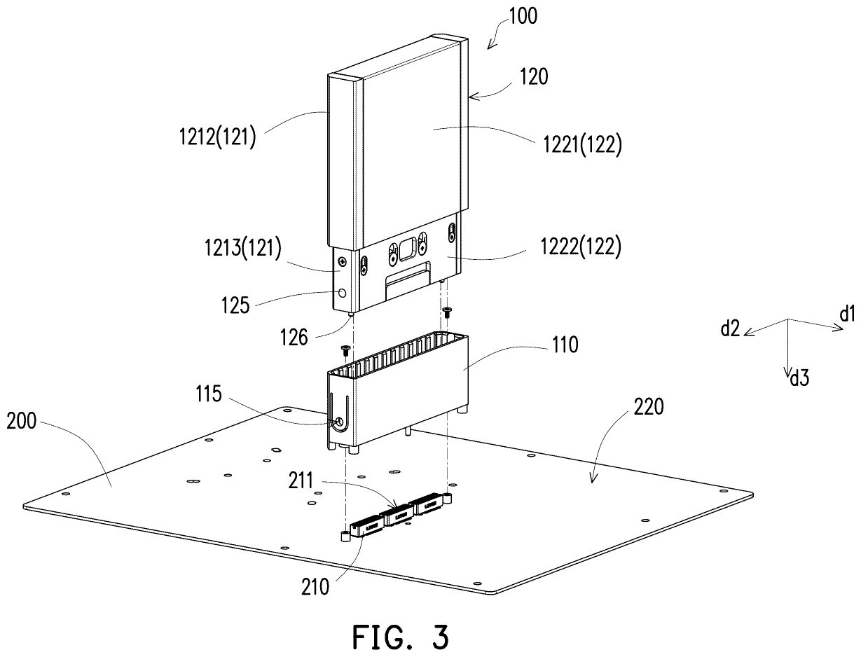

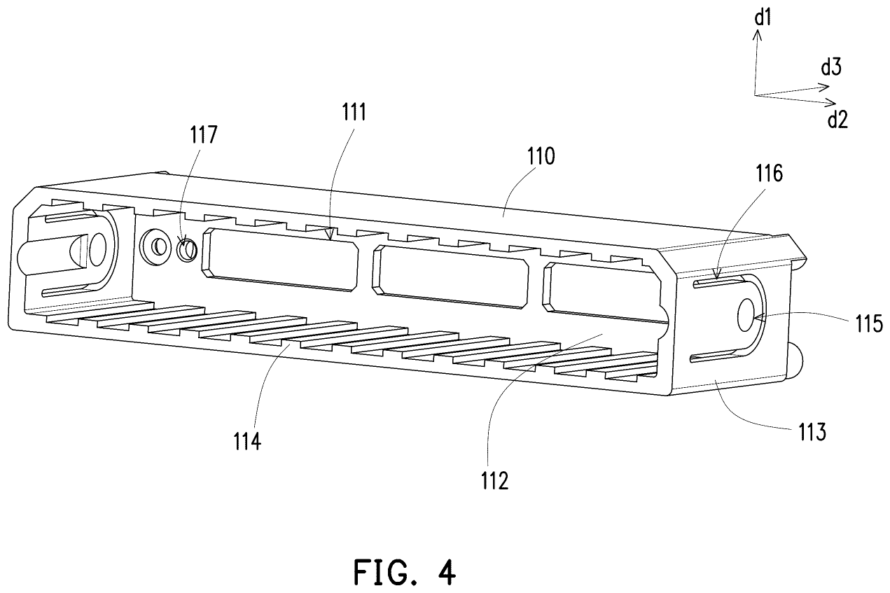

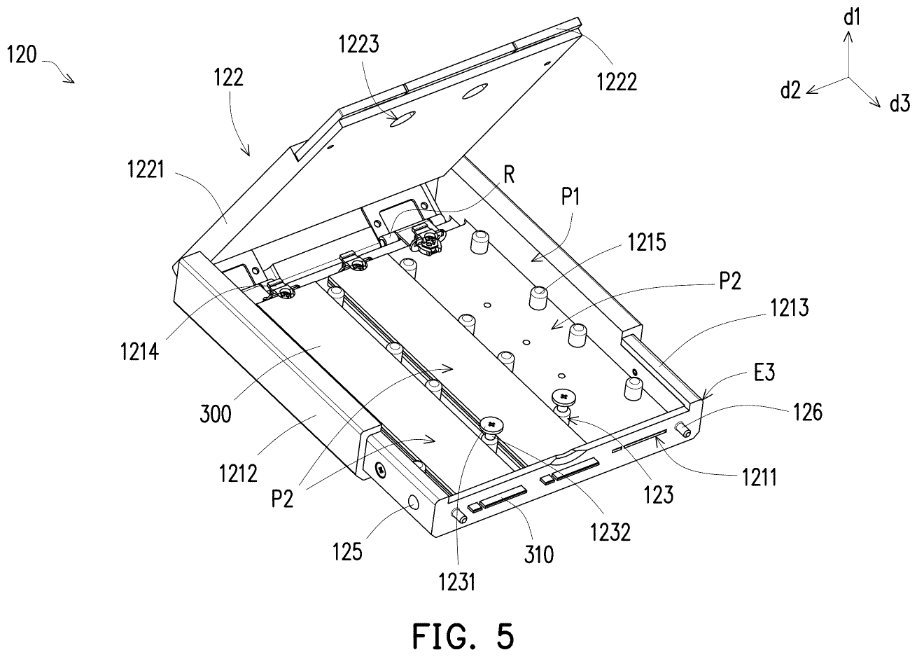

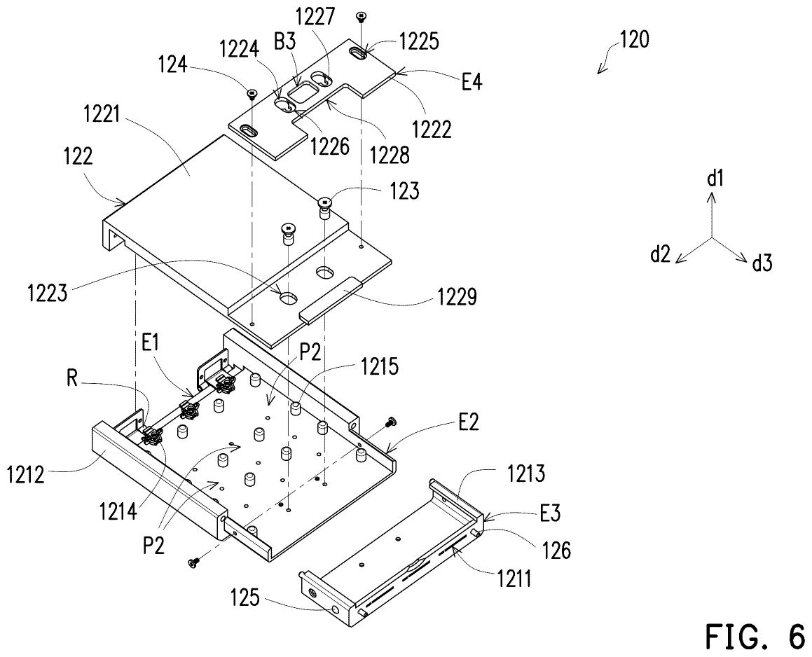

FIG. 1 is a schematic diagram of an interface connection structure according to an embodiment of the disclosure. FIG. 2 is a cross-sectional view of the interface connection structure of FIG. 1. FIG. 3 is an exploded view of the interface connection structure of FIG. 1. FIG. 4 is a schematic diagram of the base of FIG. 3. FIG. 5 is a schematic diagram of the heat dissipation connection structure of FIG. 3 after being opened. FIG. 6 is an exploded view of the heat dissipation connection structure of FIG. 3. A first direction d1, a second direction d2, and a plugging direction d3, which are perpendicular to each other, are provided herein to facilitate component description. Referring to FIG. 1 to FIG. 6, the interface connection structure 100 is configured to connect at least one interface device 300 to a circuit board 200. The circuit board 200 has at least one connector 210. The interface connection structure 100 includes a base 110 and a heat dissipation connection structure 120. The base 110 is disposed on the circuit board 200 along the plugging direction d3 and includes at least one connector opening 111. The at least one connector 210 is located within the at least one connector opening 111. The heat dissipation connection structure 120 may be detachably connected to the base 110 along the plugging direction d3. The plugging direction d3 is perpendicular to a surface 220 of the circuit board 200. In this embodiment, the number of connectors 210 is three, and the number of interface devices 300 is two, but is not limited thereto.

Each connector 210 has a slot 211, and the slot 211 extends along the plugging direction d3. The heat dissipation connection structure 120 includes a first casing 121 and a second casing 122. The second casing 122 is movably connected to the first casing 121 through a hinge R, and encloses an accommodation space P1 with the first casing 121. The accommodation space P1 may accommodate the interface device 300. Each interface device 300 has a connecting portion 310. The first casing 121 includes at least one connection opening 1211, and the connection opening 1211 communicates with the accommodation space P1. When the interface device 300 is disposed in the heat dissipation connection structure 120, the connecting portion 310 of the interface device 300 is exposed from the corresponding connection opening 1211. At this time, the heat dissipation connection structure 120 may be connected to the base 110 along the plugging direction d3, thereby inserting the connecting portion 310 into the slot 211 of the corresponding connector 210.

Thereby, the interface device 300 is stably maintained within the heat dissipation connection structure 120, and is stably connected to the connector 210 of the circuit board 200 through the base 110. The interface device 300 is directly connected to the circuit board 200 through the interface connection structure 100, without the need to connect to the circuit board 200 through an adaption card (not shown). The process of connecting and detaching the heat dissipation connection structure 120 to and from the base 110 does not require the use of tools, thus achieving tool-free assembly and disassembly. In this embodiment, the interface device 300 is an M.2 interface card, and the corresponding connector 210 of the circuit board 200 is an M.2 connector. The connector 210 may be an NVMe (NVM Express) connector.

As shown in FIG. 3, the base 110 further includes a bottom surface 112, a side surface 113, and a plurality of guide ribs 114. The side surface 113 surrounds and connects to the bottom surface 112, the connector openings 111 are located on the bottom surface 112, and the guide ribs 114 are connected to the side surface 113 and extend along the plugging direction d3. When the heat dissipation connection structure 120 is connected to the base 110, the guide ribs 114 contact the heat dissipation connection structure 120 to reduce the contact area between the base 110 and the heat dissipation connection structure 120, thereby reducing the friction between the base 110 and the heat dissipation connection structure 120, avoiding excessive friction that may make it difficult to plug and unplug the heat dissipation connection structure 120.

As shown in FIG. 1 to FIG. 3, the heat dissipation connection structure 120 has a heat dissipation area A1 and a connecting area A2. The ranges of the heat dissipation area A1 and the connecting area A2 are defined according to the connection way between the heat dissipation connection structure 120 and the base 110. When the heat dissipation connection structure 120 is connected to the base 110, the connecting area A2 is located in the base 110, while the heat dissipation area A1 is exposed. A portion of the first casing 121 and the second casing 122 is located in the heat dissipation area A1, and the other portion of the first casing 121 and the second casing 122 is located in the connecting area A2. The connection opening 1211 is located in the connecting area A2.

The material of the portions of the first casing 121 and the second casing 122 located in the heat dissipation area A1 may include metal with better thermal conductivity properties, such as aluminum. When the interface device 300 is placed in the heat dissipation connection structure 120, a portion of the interface device 300 is located in the heat dissipation area A1 and is thermally coupled to the heat dissipation connection structure 120, thereby increasing the heat dissipation area of the interface device 300 and improving the heat dissipation efficiency of the interface connection structure 100. The interface connection structure 100 may optionally further include a cooling device 130. The cooling device 130 is disposed in the heat dissipation area A1 of the heat dissipation connection structure 120. When the interface device 300 is disposed in the heat dissipation connection structure 120, the cooling device 130 is thermally coupled to the interface device 300 to improve the heat dissipation performance of the interface connection structure 100. The cooling device 130 may be disposed on the first casing 121 and/or the second casing 122. The cooling device 130 includes, but is not limited to: a heat sink fin and a fan. For example, the heat sink fin may be integral with the heat dissipation connection structure 120, and the fan may be externally mounted on the heat dissipation connection structure 120 through fixtures, but not limited thereto.

As shown in FIG. 2, FIG. 5, and FIG. 6, the first casing 121 of the heat dissipation connection structure 120 includes a first component 1212 and a second component 1213 connected to each other, and the second casing 122 includes a third component 1221 and a fourth component 1222. The third component 1221 of the second casing 122 is rotatably connected to one end E1 of the first component 1212 of the first casing 121. The connection opening 1211 of the heat dissipation connection structure 120 is located on the second component 1213 of the first casing 121, and the other end E2 of the first component 1212 is connected to the second component 1213 through a fixture. The fourth component 1222 is slidably connected to the third component 1221, the second component 1213 and the fourth component 1222 are located in the connecting area A2. When the heat dissipation connection structure 120 is connected to the base 110, the second component 1213 and the fourth component 1222 are located within the base 110. In this embodiment, the material of the first component 1212 and the third component 1221 may be metal with better thermal conductivity properties, such as aluminum, but not limited thereto. The material of the second component 1213 and the fourth component 1222 may be plastic, but not limited thereto.

The first casing 121 may optionally include a plurality of positioning members 1214 and a plurality of guide posts 1215 disposed in the first component 1212. The guide posts 1215 are arranged along the plugging direction d3 to divide the accommodation space P1 into a plurality of accommodation subspaces P2. The interface devices 300 may be disposed in the accommodation subspaces P2. The positioning members 1214 may stably position the corresponding interface device 300 disposed in the accommodation subspace P2 in the heat dissipation connection structure 120 through any known way.

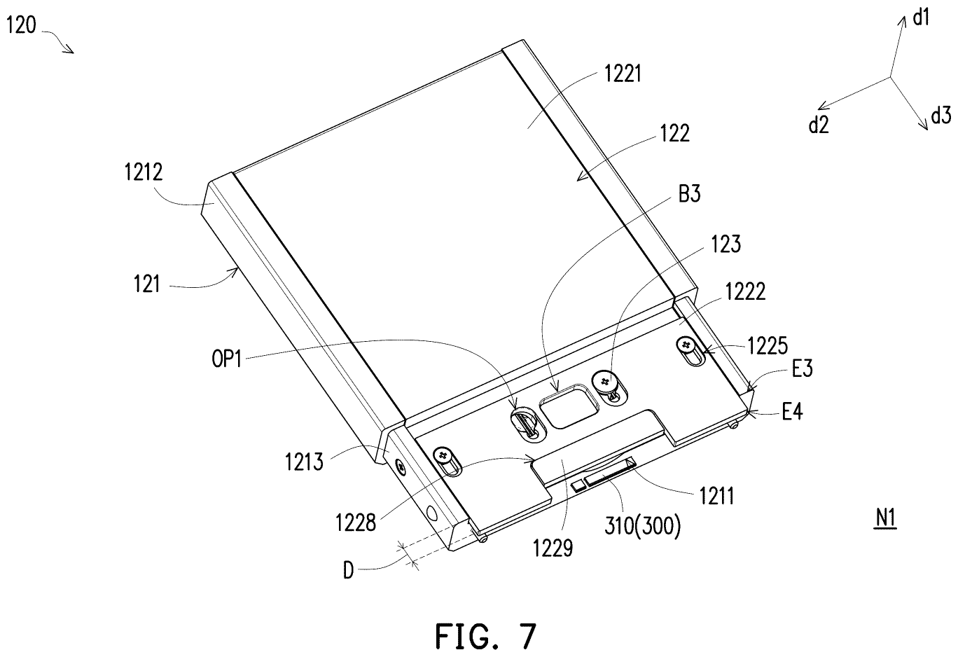

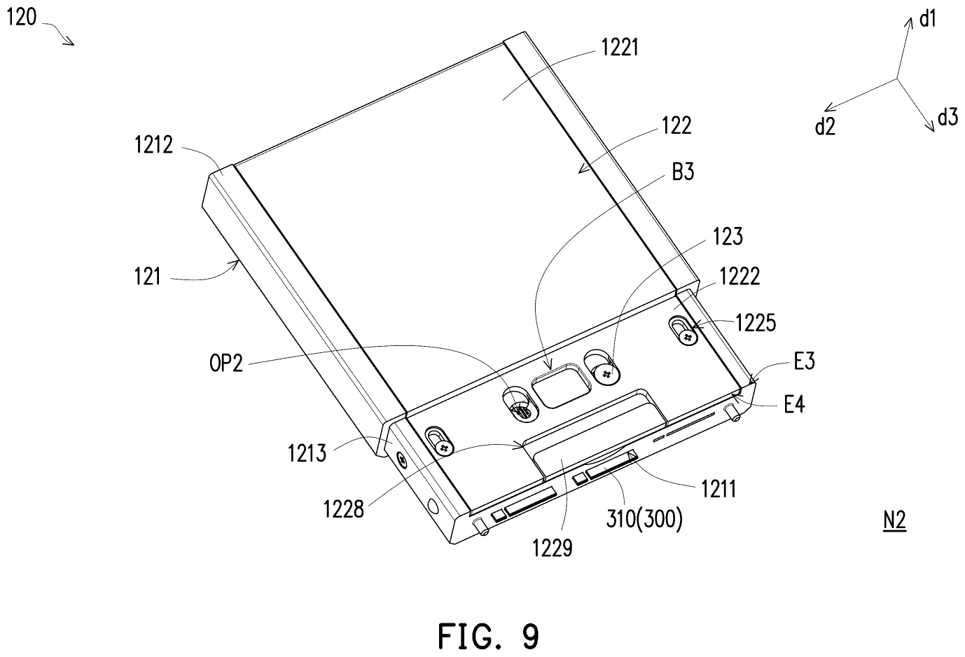

The heat dissipation connection structure 120 further includes a connecting member 124. The third component 1221 includes a first sliding groove 1223, and the fourth component 1222 includes a second sliding groove 1224 and an auxiliary sliding groove 1225. The first sliding groove 1223, the second sliding groove 1224, and the auxiliary sliding groove 1225 extend along the plugging direction d3. The shape of the second sliding groove 1224 is gourd-shaped, but not limited thereto. The connecting member 124 is connected to the third component 1221 and passes through the auxiliary sliding groove 1225, allowing the fourth component 1222 to be movably connected to the third component 1221, and may switch between a first position N1 (shown in FIG. 7) and a second position N2 (shown in FIG. 9) along the plugging direction d3. When the fourth component 1222 is in different positions, different parts of the first sliding groove 1223 and the second sliding groove 1224 form corresponding through holes.

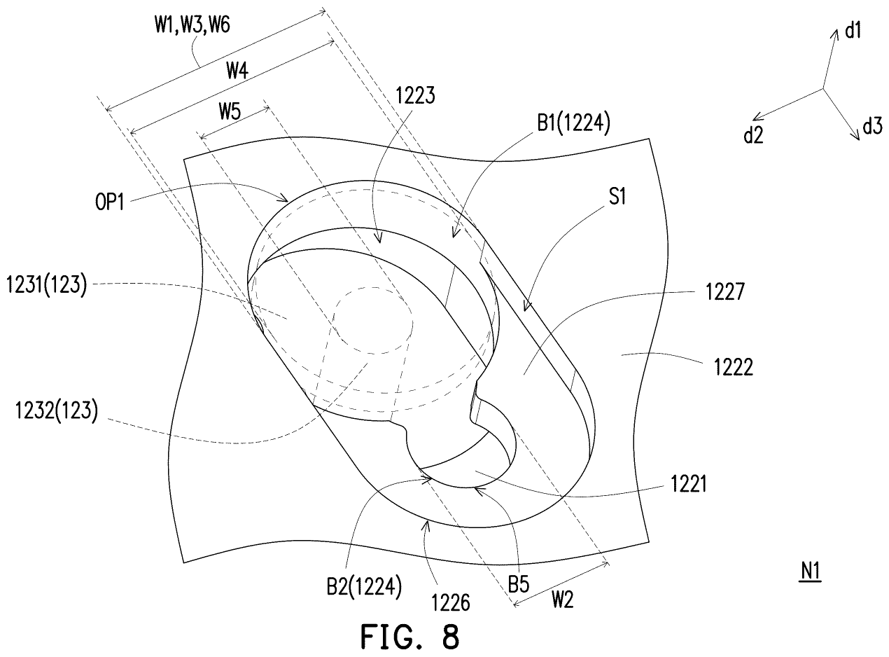

FIG. 7 is a schematic diagram of the fourth component of FIG. 6 in the first position. FIG. 8 is a partially enlarged view of the fourth component of FIG. 7. Referring to FIG. 5 to FIG. 8, specifically, the fourth component 1222 includes an opening 1226 and a limiting member 1227. The opening 1226 extends along the plugging direction d3. The limiting member 1227 is connected to an inner side surface S1 of the opening 1226 and includes a groove recessed along the plugging direction d3. The opening 1226 and the groove of the limiting member 1227 together form the second sliding groove 1224. A width W1 of a first portion B1 of the second sliding groove 1224 in the direction perpendicular to the plugging direction d3 (i.e., the second direction d2) is greater than a width W2 of a second portion B2 of the second sliding groove 1224, and is equal to a width W3 of the opening 1226. The width W2 of the second portion B2 is equal to a width of the groove of the limiting member 1227. The thickness of the limiting member 1227 in the direction perpendicular to the plugging direction d3 (i.e., the first direction d1) is less than the thickness of the opening 1226, but not limited thereto.

The heat dissipation connection structure 120 further includes a locking member 123. The locking member 123 is disposed in the first component 1212 of the first casing 121. The locking member 123 includes a head 1231 and a neck 1232 connected to each other. A width W4 of the head 1231 in the direction perpendicular to the plugging direction d3 (i.e., the second direction d2) is greater than a width W5 of the neck 1232. When the fourth component 1222 is in the first position N1, the first sliding groove 1223 and the first portion B1 of the second sliding groove 1224 form a first through hole OP1. The width W6 of the first through hole OP1 (i.e., the width W3 of the first portion B1) is greater than or equal to the width W4 of the head 1231 of the locking member 123. Thereby, the locking member 123 releases the second casing 122, and the second casing 122 may rotate relative to the first casing 121. When the second casing 122 is closed on the first casing 121, the neck 1232 of the locking member 123 passes through the first through hole OP1 (i.e., the first sliding groove 1223 and the first portion B1 of the second sliding groove 1224), and the head 1231 of the locking member 123 is located within the opening 1226 of the second sliding groove 1224. There is a distance D between an end E3 of the second component 1213 away from the hinge R and an end E4 of the fourth component 1222 away from the hinge R. The distance D is greater than zero.

FIG. 9 is a schematic diagram of the fourth component of FIG. 7 in the second position. 10 is a partially enlarged view of the fourth component of FIG. 9. The fourth component 1222 may slide relative to the third component 1221 along the plugging direction d3 to the second position N2 under force. When the fourth component 1222 is in the second position N2, the distance between the end E3 of the second component 1213 and the end E4 of the fourth component 1222 is zero. The first sliding groove 1223 and the second portion B2 of the second sliding groove 1224 form a second through hole OP2. A width W7 of the second through hole OP2 (i.e., the width W2 of the second portion B2) is smaller than the width W4 of the head 1231 and greater than or equal to the width W5 of the neck 1232. In this embodiment, the width W7 is greater than the width W4, but not limited thereto. Thereby, the head 1231 of the locking member 123 may limit the movement of the second casing 122 (the limiting member 1227) relative to the first casing 121 in the first direction d1 and the second direction d2, thus limiting the rotation of the second casing 122 relative to the first casing 121, so that the second casing 122 is stably closed on the first casing 121.

When the heat dissipation connection structure 120 is connected to the base 110 (shown in FIG. 1), the fourth component 1222 may be in the first position N1. During the process of inserting into the base 110, the fourth component 1222 is pushed by the bottom surface 112 (shown in FIG. 4) of the base 110 to move to the second position N2. The user may also first move the fourth component 1222 to the second position N2 before inserting the heat dissipation connection structure 120 into the base 110.

In addition, as shown in FIG. 7 and FIG. 9, the fourth component 1222 of the second casing 122 further includes an operating opening B3 and a recess 1228, and the third component 1221 of the second casing 122 further includes a protrusion 1229. The user's fingers may push the fourth component 1222 through the operating opening B3, and the cooperation of the protrusion 1229 and the recess 1228 may limit the sliding distance of the fourth component 1222 relative to the third component 1221.

As shown in FIG. 3 and FIG. 4, the base 110 further includes a first positioning hole 115, an auxiliary opening 116, and a second positioning hole 117. The heat dissipation connection structure 120 further includes a first positioning protrusion 125 and a second positioning protrusion 126. The first positioning hole 115 and the auxiliary opening 116 are located on the side surface 113 of the base 110, and the auxiliary opening 116 is U-shaped and surrounds the first positioning hole 115. The second positioning hole 117 is located on the bottom surface 112 of the base 110. The first positioning protrusion 125 extends along the second direction d2, and the second positioning protrusion 126 extends along the plugging direction d3. The first positioning protrusion 125 and the second positioning protrusion 126 are located on the second component 1213 of the first casing 121, and correspond to the first positioning hole 115 and the second positioning hole 117, respectively.

When the heat dissipation connection structure 120 is connected to the base 110, the first positioning protrusion 125 is located within the first positioning hole 115, and the second positioning protrusion 126 is located within the second positioning hole 117, allowing the heat dissipation connection structure 120 to be more stably connected to the base 110. When removing the heat dissipation connection structure 120 from the base 110, the portion of the side surface 113 of the base 110 where the first positioning hole 115 is located may undergo slight deformation through the auxiliary opening 116, thereby allowing the first positioning protrusion 125 to leave the first positioning hole 115, and the heat dissipation connection structure 120 may smoothly move away from the base 110.

In summary, the heat dissipation connection structure of the interface connection structure of the disclosure is used to hold the interface device, with the connecting portion of the interface device exposed outside the heat dissipation connection structure. The base of the interface connection structure is set on the circuit board, and the heat dissipation connection structure may be inserted into the base, allowing the connecting portion of the interface device to directly and stably connect with the connector of the circuit board.

What is claimed is:

1. An interface connection structure, adapted to a circuit board, the circuit board has at least one connector, each of the at least one connector has a slot, the slot extending along a plugging direction, and the plugging direction is perpendicular to the circuit board, the interface connection structure comprising:
a base, disposed on the circuit board, the base comprises at least one connector opening, the at least one connector is located within the at least one connector opening; and
a heat dissipation connection structure, detachably connected to the base along the plugging direction, the heat dissipation connection structure comprises a first casing and a second casing, the second casing is movably connected to the first casing and encloses an accommodation space with the first casing, the first casing comprises at least one connection opening, the accommodation space is adapted to be disposed with at least one interface device, and each of the at least one interface device has a connecting portion;
When the at least one interface device is disposed in the accommodation space, the connecting portion is exposed from the at least one connection opening, the heat dissipation connection structure is adapted to connect to the base along the plugging direction, thereby inserting the connecting portion into the slot.

2. The interface connection structure according to claim 1, wherein the first casing comprises a first component and a second component connected to each other, the second casing is movably connected to the first component, the at least one connection opening is located on the second component, when the heat dissipation connection structure is connected to the base, the second component is located within the base.

3. The interface connection structure according to claim 1, wherein the second casing comprises a third component and a fourth component, the third component is rotatably connected to the first casing, the fourth component is slidably connected to the third component, when the heat dissipation connection structure is connected to the base, the fourth component is located within the base.

4. The interface connection structure according to claim 3, wherein the heat dissipation connection structure further comprises a locking member, the third component comprises a first sliding groove, the fourth component comprises a second sliding groove, the locking member is disposed in the first casing and comprises a head and a neck connected to each other, a width of the head is greater than a width of the neck, when the second casing is closed on the first casing, the neck passes through the first sliding groove and the second sliding groove.

5. The interface connection structure according to claim 4, wherein when the fourth component is in a first position, the first sliding groove and the second sliding groove form a first through hole, a width of the first through hole is greater than or equal to the width of the head, when the fourth component is in a second position, the first sliding groove and the second sliding groove form a second through hole, a width of the second through hole is less than the width of the head and greater than or equal to the width of the neck.

6. The interface connection structure according to claim 1, wherein the heat dissipation connection structure has a heat dissipation area and a connecting area, when the at least one interface device is placed in the heat dissipation connection structure, a portion of the at least one interface device is located in the heat dissipation area and thermally coupled to the heat dissipation connection structure, when the heat dissipation connection structure is connected to the base, the connecting area is located within the base, the heat dissipation area is exposed.

7. The interface connection structure according to claim 6, wherein a portion of the first casing and the second casing is located in the heat dissipation area, another portion of the first casing and the second casing is located in the connecting area, the at least one connection opening is located in the connecting area.

8. The interface connection structure according to claim 1, further comprising a cooling device, the cooling device is disposed on the heat dissipation connection structure, when the at least one interface device is disposed in the heat dissipation connection structure, the cooling device is thermally coupled to the at least one interface device.

9. The interface connection structure according to claim 1, wherein the at least one connector of the circuit board is an M.2 connector, the at least one interface device is an M.2 interface card.

10. The interface connection structure according to claim 1, wherein the base comprises a plurality of guide ribs extending along the plugging direction, when the heat dissipation connection structure is connected to the base, the guide ribs contact the heat dissipation connection structure.
